(19) United States
(12) Patent Application Publication
(10) Pub. No.: US 2004/0165141 A1
(43) Pub. Date: Aug. 26, 2004

(54) [METHOD OF FORMING A LIQUID CRYSTAL PANEL]

(76) Inventors: Hsin-Ming Chen, Hsinchu (TW); Cheng-Hsun Tsai, Hsinchu (TW); Yu-Ting Hung, Miaoli (TW); Ching-Yang Chang, Hsinchu (TW); Shih-Chang Chang, Hsinchu (TW); Yaw-Ming Tsai, Taichung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/249,777

(22) Filed: May 7, 2003

(30) Foreign Application Priority Data
Feb. 20, 2003 (TW) 92103488

(51) Int. Cl. G02F 1/1339

(52) U.S. Cl. 349/190

(57) ABSTRACT

A method of forming a liquid crystal panel is provided. A first substrate and a second substrate are provided. A sealant having an injection opening is formed between the first substrate and the second substrate. The sealant is fabricated using an etchant resistant material. Thereafter, liquid crystals are injected into the cavity bounded by the first substrate, the second substrate and the sealant through the injection opening. After sealing the injection opening, a substrate thickness reduction process is performed to reduce the thickness of the first substrate and the second substrate.

### BACKGROUND OF INVENTION

1. Field of Invention

The present invention relates to a method of forming a liquid crystal panel. More particularly, the present invention relates to a method of reducing the overall thickness of a liquid crystal panel.

2. Description of Related Art

Liquid crystal display is a device having a wide variety of applications due to its many advantages over other types of displays. In general, a liquid crystal display is light and compact. It produces high-quality images and consumes very little power. Moreover, a low voltage can be used to drive the liquid crystal display. With all these advantages, it has been broadly applied in small to medium size portable televisions, mobile phones, camcorders, notebook computers, desktop monitors and projection televisions. In time, liquid crystal displays will displace the currently dominant cathode ray tubes (CRT).

However, to reduce the weight and volume of a display even further, a number of methods for miniaturizing the device or reducing panel thickness have been developed. In the following, a conventional method of reducing the thickness of a liquid crystal display is described.

FIGS. 1A to 1D are schematic cross-sectional views showing the steps for reducing overall thickness of a conventional liquid crystal display. First, as shown in FIG. 1A, a first substrate 100 and a second substrate 102 are provided. The first substrate 100 already has a thin film transistor array 104 formed thereon and the second substrate 102 has a color filtering film array 106 formed thereon. Thereafter, a sealant 108 with an injection opening 110 therein is formed between the first substrate 100 and the second substrate 102 so that the first substrate 100 and the second substrate 102 are assembled together. A layer of temporary sealant 112 is applied outside the sealant 108 so that the injection opening 110 is temporarily sealed.

As shown in FIG. 1B, the entire structure is immersed in a pool of liquid etchant to perform a panel thickness reduction process. After the thickness reduction process, thickness of both the first substrate 100 and the second substrate 102 is reduced to produce a thinner first substrate 100a and a thinner second substrate 102a. Since the temporary sealant 112 has the capacity to resist etching, etchant is prevented from leaking into the interior space between the two substrates to cause damages to the thin film transistor array 104 and the color filtering film array 106.

As shown in FIG. 1C, the temporary sealant 112 is removed so that the injection opening 110 is re-exposed. However, in the process of removing the temporary sealant 112, some residual compound 113 may still adhere to the areas close to the injection opening 110.

As shown in FIG. 1D, liquid crystals 114 are injected into the cavity formed by the first substrate 100a, the second substrate 102a and the sealant 108 through the injection opening 110. Finally, the injection opening 110 is sealed using a sealing material 116 to form a complete liquid crystal panel.

In the aforementioned panel thickness reduction process, some residual material 113 may stick to areas surrounding the injection opening 110 (as shown in FIG. 1C) after removing the temporary sealant 112. In the presence of the residual compound around the injection opening 110, the injected liquid crystals 114 within the cavity bounded by the first substrate 100a, the second substrate 102a and the sealant 108 will be contaminated.

Furthermore, to prevent the etchant from damaging the thin film transistor array 104 and the color filtering film array, the conventional method demands the enclosure of the sealant layer 108 with a temporary sealant 112 prior to etching and the removal of the temporary sealant 112 afterwards. Thus, the conventional method must include more processing steps.

### SUMMARY OF INVENTION

Accordingly, one object of the present invention is to provide a method of forming a liquid crystal panel capable of reducing the degree of contamination of liquid crystals inside the panel after a conventional panel thickness reduction process.

A second object of this invention is to provide a method of forming a liquid crystal panel requiring fewer processing steps than a conventional one.

To achieve these and other advantages and in accordance with the purpose of the invention, as embodied and broadly described herein, the invention provides a method of forming a liquid crystal panel. First, a first substrate and a second substrate are provided. The first substrate has a thin film transistor array already formed thereon and the second substrate has a color filtering film array already formed thereon. A sealant with an injection opening therein is formed between the first substrate and the second substrate. The sealant is fabricated using an etchant resistant material. In this invention, the sealant is fabricated using an acid/base resistant material, for example. Thereafter, liquid crystals are injected into the cavity bounded by the first substrate, the second substrate and the sealant through the injection opening. After sealing up the injection opening, a thickness reduction process is performed to reduce the thickness of the first substrate and the second substrate. The thickness reduction process is a chemical treatment process that involves, for example, etching the first substrate and the second substrate chemically. In addition, the thickness reduction process may be combined with a mechanical treatment process of the first and the second substrate.

Since the sealant within the liquid crystal panel is made from an etchant resistant material, there is no need for forming a ring of etchant resistant temporary sealant around the sealant to prevent the etchant from getting inside the panel cavity and damaging interior components.

Furthermore, because the sealant is etchant resistant, the processing steps for forming a temporary sealant around the sealant and removing the temporary sealant after the panel thickness reduction process can be deleted. In other words, at least two processing steps can be deleted resulting in a reduction in the production cost of the liquid crystal panel.

In addition, the liquid crystals are injected into the cavity between the two substrates and sealed before performing the panel thickness reduction operation. Without using any temporary sealant, contamination of the liquid crystals inside the liquid crystal panel can be prevented.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A to 1D are schematic cross-sectional views showing the steps for reducing overall thickness of a conventional liquid crystal display.

FIGS. 2A to 2C are schematic cross-sectional views showing the steps for reducing overall thickness of a liquid crystal panel according to one preferred embodiment of this invention.

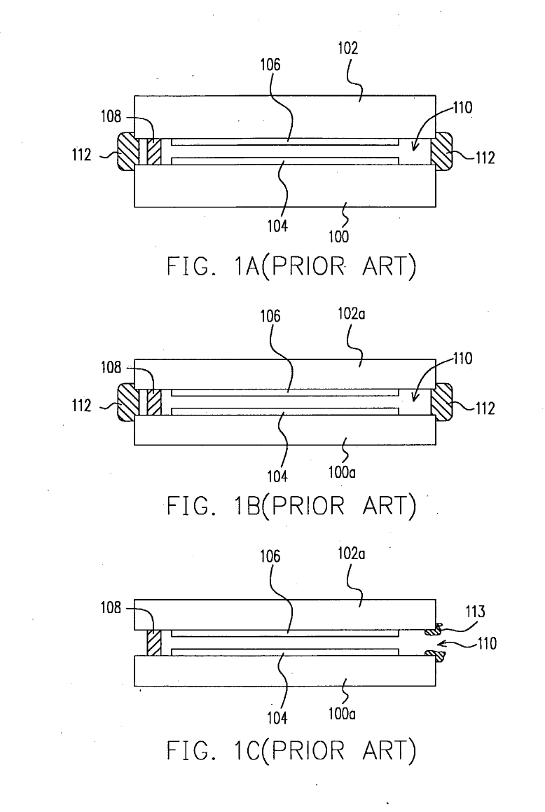

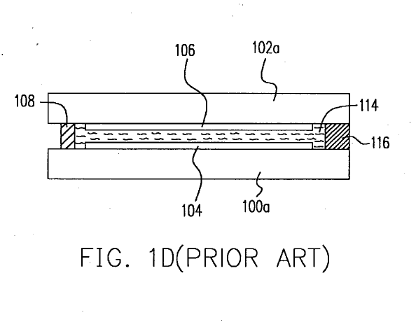

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

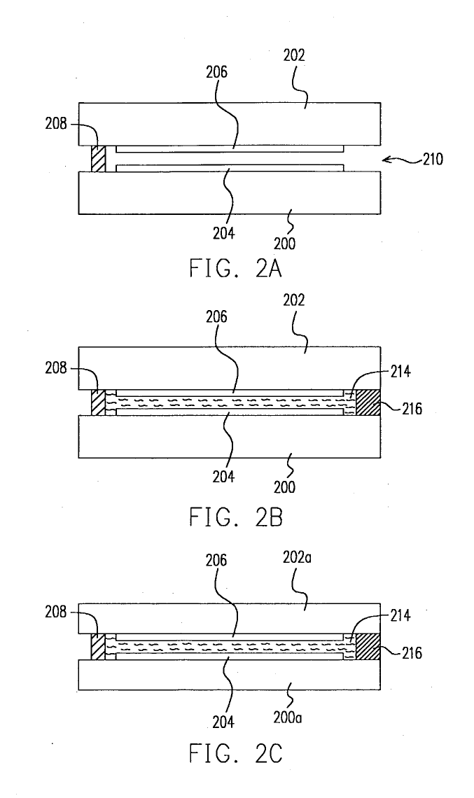

FIGS. 2A to 2C are schematic cross-sectional views showing the steps for reducing overall thickness of a liquid crystal panel according to one preferred embodiment of this invention. First, as shown in FIG. 2A, a first substrate 200 and a second substrate 202 are provided. The first substrate 200 and the second substrate 202 are transparent glass substrates or transparent plastic substrates, for example. Furthermore, the first substrate 200 has a thin film transistor array 204 already formed thereon and the second substrate 202 has a color filtering film array 206 already formed thereon.

The thin film transistor array 204 comprises, for example, a plurality of scan lines, a plurality of data lines, a plurality of thin film transistors and a plurality of pixel electrodes. Obviously, the first substrate 200 may also include some other films (for example, polarizing films, diffusion films, reflective films, optical films and so on)(not shown). The color filtering film array 206 comprises, for example, a plurality of red filtering films (R), green filtering films (G) and blue filtering films (B). Furthermore, the red, green and blue films are separated from each other through a black matrix, for example. The color filtering film array 206 may furthermore include a common electrode (not shown). Similarly, the second substrate 202 may also include other films (for example, polarizing films, optical films and so on)(not shown).

A sealant 208 is formed between the first substrate 200 and the second substrate 202. The sealant 208 has an injection opening 210. The sealant 208 is fabricated using an etchant-resistant material. In this embodiment of the invention, the sealant 208 is an acid/base resistant material, for example.

As shown in FIG. 2B, liquid crystals are injected into the cavity bounded by the first substrate 200, the second substrate 202 and the sealant 208 through the injection opening 210. Thereafter, the injection opening 210 is sealed using a piece of sealing material 216. After the sealing operation, a functional liquid crystal panel is formed although the panel is still relatively thick. The sealing material 216 is similarly fabricated using an etchant-resistant material.

As shown in FIG. 2C, a substrate thickness reduction process is performed to convert the first substrate 200 and the second substrate 202 into a thinner first substrate 200a and a thinner second substrate 202a. The substrate thickness reduction process is a chemical treatment, for example. In this embodiment, the chemical treatment includes immersing the liquid crystal panel in a pool of liquid etchant to remove a layer from the substrates. Because the sealant 208 and the sealing material 216 are both fabricated from an etchant-resistant material, the etchant is prevented from entering the interior of the liquid crystal panel to damage the internal components during the chemical treatment. In addition, the substrate thickness reduction process may selectively combine with other mechanical treatments. After the substrate thickness reduction process, overall thickness of the liquid crystal panel is reduced considerably.

Because the sealant 208 and the sealing material 216 are etchant resistant, there is no need to form a temporary sealant around the sealant to prevent the etchant from getting into the panel cavity and damaging the internal components. Without forming any temporary sealant, the step for removing the temporary sealant after the panel thickness reduction process is no longer needed. In other words, at least two processing steps are eliminated, resulting in a reduction in the production cost of the liquid crystal panel. In addition, the liquid crystals 214 are injected into the cavity bounded by the two substrates (200, 202) and the sealant 208 before performing the panel thickness reduction operation. Without using any temporary sealant, contamination of the liquid crystals 214 inside the liquid crystal panel during the injection process is prevented.

In summary, major advantages of this invention includes:1. There is no need to form a layer of temporary sealant around the sealant of the liquid crystal panel prior to performing a substrate thickness reduction process and to remove the temporary sealant the substrate thickness reduction process. Thus, the processing treatment is simplified and the production cost is reduced.

2. Without using any temporary sealant, the liquid crystals inside the panel will not be contaminated during the crystal injection process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method of forming a liquid crystal panel, comprising the steps of:
providing a first substrate and a second substrate;
forming a sealant between the first substrate and the second substrate, wherein the sealant has an injection hole therein and that the sealant is fabricated using an etchant resistant material;
injecting liquid crystals into the cavity bounded by the first substrate, the second substrate and the sealant through the injection opening;
sealing the injection opening; and
performing a substrate thickness reduction process so that overall thickness of both the first substrate and the second substrate are reduced.

2. The method of claim 1, wherein the sealant is fabricated using an acid/base resistant material.

3. The method of claim 1, wherein the step of sealing the injection opening includes plugging a piece of etchant resistant sealing material into the injection opening.

4. The method of claim 1, wherein the substrate thickness reduction process comprises performing a chemical treatment.

5. The method of claim 4, wherein the chemical treatment process comprises etching the first substrate and the second substrate to reduce their overall thickness.

6. The method of claim 4, wherein the substrate thickness reduction process furthermore comprises performing a mechanical treatment.

7. The method of claim 1, wherein the first substrate at least comprises a thin film transistor array formed thereon.

8. The method of claim 1, wherein the second substrate at least comprises a color filtering film array formed thereon.

9. A method of reducing overall thickness of a liquid crystal panel, comprising the steps of:
fabricating a liquid crystal panel; and
performing a chemical treatment of the liquid crystal panel so that thickness of the liquid crystal panel is reduced, wherein a sealant within the liquid crystal panel is fabricated using an etchant resistant material.

10. The method of claim 9, wherein the sealant is fabricated using an acid/base resistant material.

11. The method of claim 9, wherein the chemical treatment comprises performing an etching process.

12. The method of claim 9, wherein the chemical treatment furthermore comprises performing a mechanical treatment.
